(19) United States
(12) Patent Application Publication
(10) Pub. No.: US 2013/0121490 A1
(43) Pub. Date: May 16, 2013

(54) METHOD AND APPARATUS FOR TRUST BASED DATA SCANNING, CAPTURE, AND TRANSFER

(71) Applicants: Martin Boliek, San Francisco, CA (US); David Clark, San Jose, CA (US)

(72) Inventors: Martin Boliek, San Francisco, CA (US); David Clark, San Jose, CA (US)

(21) Appl. No.: 13/676,580

(22) Filed: Nov. 14, 2012

Related U.S. Application Data
(60) Provisional application No. 61/641,735, filed on May 2, 2012.
(60) Provisional application No. 61/560,193, filed on Nov. 15, 2011.

(51) Int. Cl. H04L 9/28

(52) U.S. Cl. CPC H04L 9/28
USPC 380/255

(57) ABSTRACT

A method and apparatus for enabling trust based data scanning and capture is described. The method may include capturing data with a data capture device. The method may also include encrypting the data with a first encryption key, encrypting the first encryption key with a second encryption key to generate a first encrypted key data, and encrypting the first encrypted key data with a third encryption key to generate a second encrypted key data. The method may also include transmitting the encrypted data and the second encrypted key data to a remote service provider over a network.

### RELATED APPLICATIONS

This application claims the benefit of U.S. Provisional Patent Application No. 61/641,735, filed May 2, 2012, and U.S. Provisional Patent Application No. 61/560,193 filed Nov. 15, 2011, and incorporates both applications in their entirety by reference.

### TECHNICAL FIELD

Embodiments of the invention relate to the field of data security, and more particularly, to enabling trust based data scanning and capture.

### BACKGROUND

There are many elements that contribute to, or detract from, trust in the digital world. As people store more personal documents and data on the Internet, trust becomes more important.

Trust in data and systems is multifaceted. It is not just security that is important. Authentication, traceability, accessibility, and privacy all play an important part. Furthermore, the human characteristics of credibility, consistency, competence, confidence, and character play as important a role online as they do in human interaction and trust.

There are many known data trust algorithms. Symmetric key encryption algorithms, such as the Advanced Encryption System (AES) approved by the National Institute of Standards and Technology (NIST), use the same key to both encrypt and decrypt data. Asymmetric key encryption, such as the Pretty Good Privacy (PGP) owned by Symantec™, uses a different key for encryption and decryption.

The quality of security and authentication provided by these encryption algorithms is more a function of key management and system design than the quality of the encryption algorithms themselves. For example, the basis of Public/Private key encryption is that asymmetric encryption keys are distributed in such a way that one is held strictly confidential (private) and the other is given to a receiving party and is possibly freely available (public).

Another common algorithm is a hash function, e.g. MD-5, SHA1, SHA256, etc. Hash functions have the property that when processing any block of data, regardless of the size of that data, a unique (or statistically unique) fixed-length number is returned. The same block of data will return the same number; however, a block of data with even one bit of different data will return a very different hash value. This is the hash signature of the data. Note that the block of data is not determinable given just the returned hash value—the hash function creates a one way index value.

These tools are the basis of many network security functions such as assuring transfer data integrity (TCP/IP), password protection, digital signatures, and secure network protocols (e.g., HTTPS, SSL).

Trust and security, like a chain, are only as strong as the weakest link. While a network secures individual data packet transfers, the source and destination computing systems are another matter. Many data collection systems such as document scanners, magnetic card readers, barcode readers, signature pads, are directly connected to a computer, or other device, and do not incorporate any security technology. Instead, the reliance is on the connected computer for security. Given the number of security attacks on computing systems such as the Windows™ operating system from Microsoft Corporation, such reliance does not ensure data security.

Thus, there is no direct security offered by the data collection systems. No authentication derives from these devices, the use of these devices as components in a multi-factor authentication system are lost, and data tracking, the chain of custody (provenance), and proof of data integrity do not start with these devices.

### SUMMARY OF THE INVENTION

The embodiments discussed herein combine data security, source authentication, and data tracking systems at a source of data capture, such as at an image scanner, barcode reader, radio frequency identification (RFID) scanner, magnetic card reader, etc. By performing encryption at the source of the data capture, the provenance and trust in the data is improved.

Furthermore, the embodiments discussed herein simultaneously enable data security, by ensuring that transferred data can only be seen by the intended recipient, source authentication, by ensuring transferred data is only sent by a specific device, data integrity, by ensuring transferred data is correct and complete, and data tracking, by providing a record as to where transferred data has been.

In one embodiment, encryption and hashing functions are performed on a data capture device, rather than on a computing or network device to which the data capture device is connected. In one embodiment, complementary decryption and hashing functions are performed at various known intermediate computing devices or network nodes, as well as at a destination device, such as a web-based service provider.

In one embodiment, for security, encryption is performed at a data capture device using a destination device's, such as a web-based service provider's, public encryption key. This public key is available to the capture device and may also be available to other devices. The private key is used for decryption and is available only to the destination device. Therefore, only the destination device can decode the encrypted data. The capture device can be certain of security, that is, only the destination device will have access to the data.

In one embodiment, for authentication, encryption is performed at a data capture device using the data capture device's private encryption key. This private key is available only to the capture device. The public key is used for decryption and is available to the destination device and may also be available to other devices. Therefore, the data can only originate at the data capture device. The destination device can be certain of authentication.

In one embodiment, for data integrity and tracking, hashes are performed on data captured by a capture device before and/or after each encryption. In one embodiment, these hashes are stored on the data capture device, and are transmitted along with the data to enable verification that data is unaltered and complete. In one embodiment, these hashes are incorporated in a log of activity that may include other entries. These entries and logs themselves are hashed and those values placed in the log. This entangles the log in such a way that it is self-validating.

These building blocks are used in the embodiments discussed herein in various ways to achieve different effects. For example, in some embodiments, the security enabling encryption is performed before the authentication enabling encryption, which enables devices and proxy nodes in the network with access to the authentication public key to perform authentication without access to the securely encrypted data. In other embodiments, the authentication enabling encryption is performed before the security enabling encryption to prevent exactly this intermediate authentication allowing only the destination device (or a device with access to both the security and authentication decryption keys) to authenticate the source of the data.

In some embodiments, the data is encrypted using a symmetric key produced or available at the data capture device. Furthermore, in some embodiments, the security and authentication enabling public/private encryptions are performed on the symmetric key itself, rather than the entire data stream. This achieves the same levels of security and authentication while incurring less CPU, time, and memory costs when performing the more complex asymmetric algorithms multiple times on the entirety of the data.

In some embodiments, the hash function creates unique index values of the unencrypted data (and possibly versions of the data as it is multiply encrypted) that are transmitted along with captured data. In some embodiments, these unique index values are sent in an unencrypted form to allow nodes of the network to record the passing of the data and check for data integrity. Other embodiments incorporate these unique index values in the encrypted data so that only allowed nodes in the network, which have access to corresponding decryption keys, can decrypt the hash value(s) and record the passing of data.

In some embodiments, the data capture device stores the unique index values in a log on the data capture device. With appropriate queries, including secure and authenticated requests, the log responds with the relevant index data in a provable and verifiable form. Thus, the data capture device becomes the provable provenance of the data.

### BRIEF DESCRIPTION OF THE DRAWINGS

The present invention will be understood more fully from the detailed description given below and from the accompanying drawings of various embodiments of the invention, which, however, should not be taken to limit the invention to the specific embodiments, but are for explanation and understanding only.

FIG. 1 is a block diagram of exemplary system architecture for enabling the secure exchange of data between a device and a service provider.

FIG. 2 is a block diagram of one embodiment of a data capture device and a service provider.

FIG. 3A is a flow diagram of one embodiment of a process performed at a data capture device to enable high security and provides no access to captured data until a service provider decrypts it.

FIG. 3B is a flow diagram of a process performed at a service provider with high security and a symmetric key.

FIG. 4A is a flow diagram of one embodiment of a process performed at a data capture device that enables authentication that occurs in many places, and security that occurs at the recipient.

FIG. 4B is a flow diagram of a process performed at a service provider that includes authentication first and using a symmetric key.

FIG. 5A is a flow diagram of one embodiment of a process performed at a data capture device without symmetric encryption while maintaining a high level of security.

FIG. 5B is a flow diagram of one embodiment of a process performed at a service provider with high security using asymmetric keys.

FIG. 6A is a flow diagram of a process performed at a data capture device with no symmetric encryption, and where authentication is performed at many locations with security at the recipient.

FIG. 6B is a flow diagram of a process performed at a service provider where authentication occurs first using asymmetric keys.

FIG. 7A illustrates one embodiment of a system in which the trust enablement techniques discussed herein is deployed for magnetic card read/write in a financial system application.

FIG. 7B illustrates another embodiment of a system in which the trust enablement techniques discussed herein is deployed for magnetic card read/write in a financial system application.

FIG. 8 illustrates another embodiment of a system in which the trust enablement techniques discussed herein is deployed for combination of an image scanner for a business application.

FIG. 9 illustrates a diagrammatic representation of a machine in the exemplary form of a computer system.

### DETAILED DESCRIPTION OF THE INVENTION

In the following description, numerous details are set forth. It will be apparent, however, to one of ordinary skill in the art having the benefit of this disclosure, that the present invention may be practiced without these specific details. In some instances, well-known structures and devices are shown in block diagram form, rather than in detail, in order to avoid obscuring the present invention.

Some portions of the detailed description that follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “capturing”, “encrypting”, “decrypting”, “transmitting”, “receiving”, “processing”, “adding”, “hashing”, “indexing”, “verifying data integrity”, “recording”, “logging”, “requesting”, or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

The present invention also relates to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions. The computer program may be delivered over a network for execution on the computer's main operating system, or on a virtual machine operating system, or inside a browser-like program or browser-plugin.

The algorithms and displays presented herein are not inherently related to any particular computer or other apparatus. Various general purpose systems may be used with programs in accordance with the teachings herein, or it may prove convenient to construct a more specialized apparatus to perform the required method steps. The required structure for a variety of these systems will appear from the description below. In addition, the present invention is not described with reference to any particular programming language. It will be appreciated that a variety of programming languages and other tools may be used to implement the teachings of the invention as described herein.

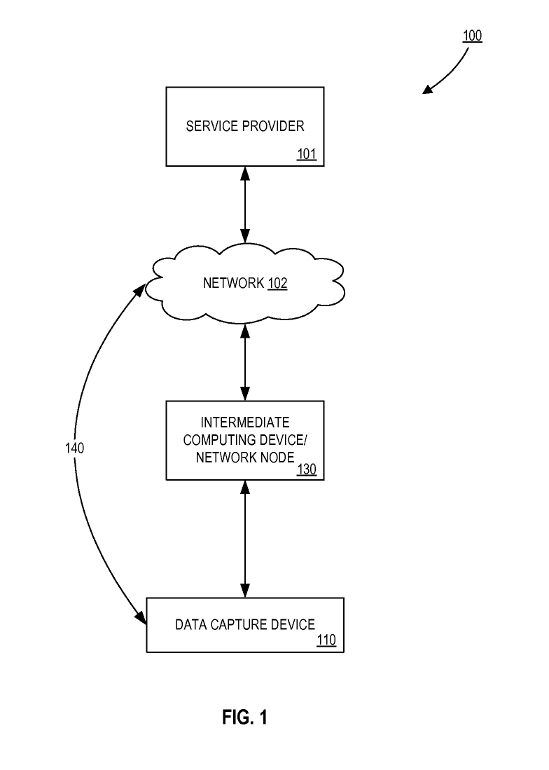

FIG. 1 is a block diagram of exemplary system architecture 100 for enabling the secure exchange of data between a data capture device and a service provider. In one embodiment, the system 100 includes data capture device 110, intermediate computing device/network node 130, a network connection that may contain computers that serve as routers and nodes or they could be interactive proxies 102, and service provider 101. In one embodiment, service provider 101 and intermediate computer device/network node 130 may be computing devices, such as a desktop computer, laptop computer, personal digital assistant, tablet computer, a mobile telephone, a cellular communication enabled wearable device, etc.

In one embodiment, the network 102 could be one or more specific web services that the encrypted data is routed to. In one embodiment, this web service can authenticate the data and its destination. In one embodiment, the web service can decrypt the data and send it using secondary security methods (e.g. a repetition of the techniques discussed herein, or more traditional HTTPS or SSL protocols) to the service provider 101.

In one embodiment, data capture device 110 is a device for collecting data, such as an image scanner, barcode reader, radio frequency identification (RFID) scanner, magnetic card reader, physical sensor (temperature, humidity, light, etc.), location sensor, security state sensor, video sensor, etc.

In one embodiment, data capture device 110 is coupled with intermediate computing device/network node 130 via a wired or wireless connection, while intermediate computing device/network node 130 is coupled with service provider 101 via network and/or web services 102. In one embodiment, network 102 communicates using standard protocols for the exchange of information. In one embodiment, service provider 101 and intermediate computing device/network node 130 is coupled with network 102 via a wireless connection, such as a cellular telephone connection, wireless fidelity (WiFi, e.g. IEEE 802.11a-n) connection, etc. The service provider 101 and intermediate computing device/network node 130 runs on one Local Area Network (LAN) and is incorporated into the same physical or logical system, or different physical or logical systems. Alternatively, the service provider 101 and intermediate computing device/network node 130 resides on different LANs, wide area networks, cellular telephone networks, etc. that is coupled together via the Internet but separated by firewalls, routers, and/or other network devices. It should be noted that various other network configurations can be used including, for example, hosted configurations, distributed configurations, centralized configurations, etc. For example, in one embodiment, data capture device 110 is coupled directly 140 with the network 102 via a wired or wireless connection and with service provider 101.

In one embodiment, data capture device 110 has a device private encryption key used to authenticate the data capture device 110 as the device from which the data was captured. The data capture device 110 encrypts captured data with the device private encryption key and transfers the encrypted data to a receiving device, such as service provider 101 via the network 102. That receiving device decrypts the data with the capture device's public encryption key. If successful, i.e. if the data is not corrupted, the receiving device can be certain that the data capture device 110, and only the data capture device 110, could have transmitted the data. To enable the receiving device to determine which public key to use to authenticate the data, an identifier of the data capture device 110 (such as a GUID, or Mac Address, or Serial Number) is sent in the clear along with the encrypted data.

In one embodiment web services in the network 102 can authenticate the data's source as the device 110. In one embodiment, this authentication is recorded in the web service's log (not shown). In one embodiment, data capture device 110 also performs encryption on data to be transferred to service provider 101, with the service provider's public encryption key service for security purposes. In one embodiment, by encrypting the captured data with the public encryption key of the service provider's 101, only the service provider (i.e., owner of the complementary private encryption key) is able to decrypt the transferred data.

In one embodiment, data capture device 110 includes additional data before or after encryption, such as the service provider's universal resource locator (URL), an instruction set detailing the processing and disposition of the data, hash values computed from original and/or encrypted data, etc. This data accompanies data transmitted to service provider 101 to enable processing, tracking, etc. of the transmitted captured data. In one embodiment, data capture device 110 generates symmetric encryption keys to encrypt captured data.

Using these services and data, the data capture device 110 sends captured data (e.g., image data, magnetic card data, RFID data, etc.), which forms the basis of a query, data transfer, or data upload, to a service provider 101. In one embodiment, service provider 101 decrypts the encrypted data and performs one or more processes, such as storing captured data, logging captured data, performing one or more actions with the capture data, etc. In one embodiment, service provider 101 transforms, deposits, or act as a proxy for the data transmitted by image capture device. In one embodiment, service provider 101 accesses additional remote services or acts as a service proxy for data capture device 110.

In one embodiment, data captured, encrypted, and transmitted by data capture device 110 is transmitted to service provider 101 via one or more computing devices, such as intermediate computing device/network node 130. In one embodiment, the intermediate computing device/network node 130 is a tablet, personal computer, mobile phone, etc. In one embodiment, intermediate computing device/network node 130 acts as an intermediate computing network node, between data capture device 110 and service provider 101, through which data may pass.

In one embodiment, service provider 101 also transmits encrypted data to data capture device 110. In one embodiment, the transmission of data from service provider 101 to data capture device forms the basis of a download or query response. The encryption, transfer, and decryption of data from the service provider 101 to the data capture device 110 functions in a similar fashion, as discussed in the figures below, except that the transfer of data occurs in the opposite direction.

Again, an intermediate computing device/network node 130, such as a tablet, personal computer, mobile phone, etc., acts as intermediate computing network node to pass through the query or download from service provider 101 to data capture device 110. In one embodiment, data capture device 110 includes a device private encryption key for security, a services public decryption key for authentication, and performs hashing and logging functions, as discussed herein.

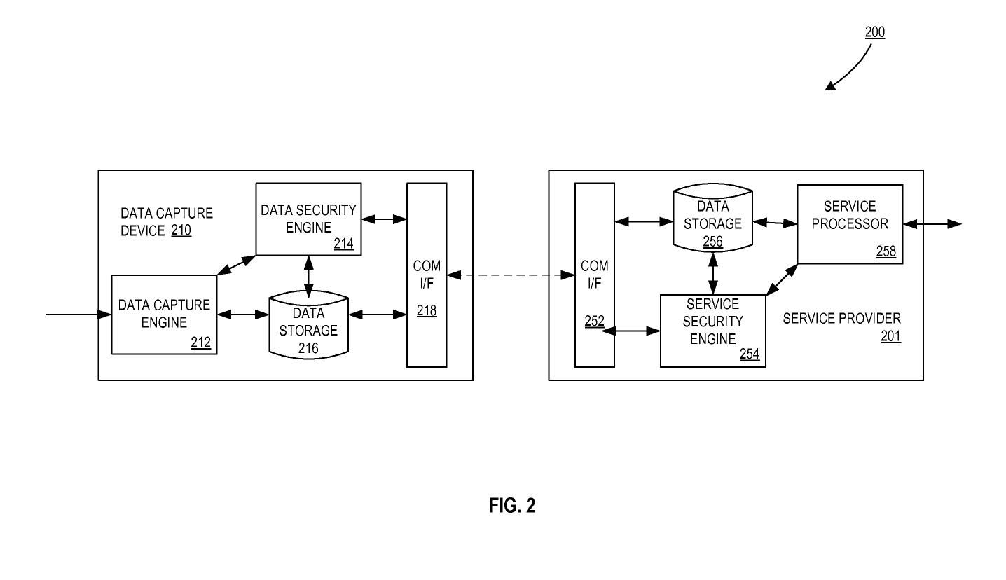

FIG. 2 is a block diagram of one embodiment 200 of a data capture device 210 and a service provider 201. Data capture device 210 and a service provider 201, as illustrated in FIG. 2, provide additional details for the data capture device 110 and a service provider 101 discussed above in FIG. 1.

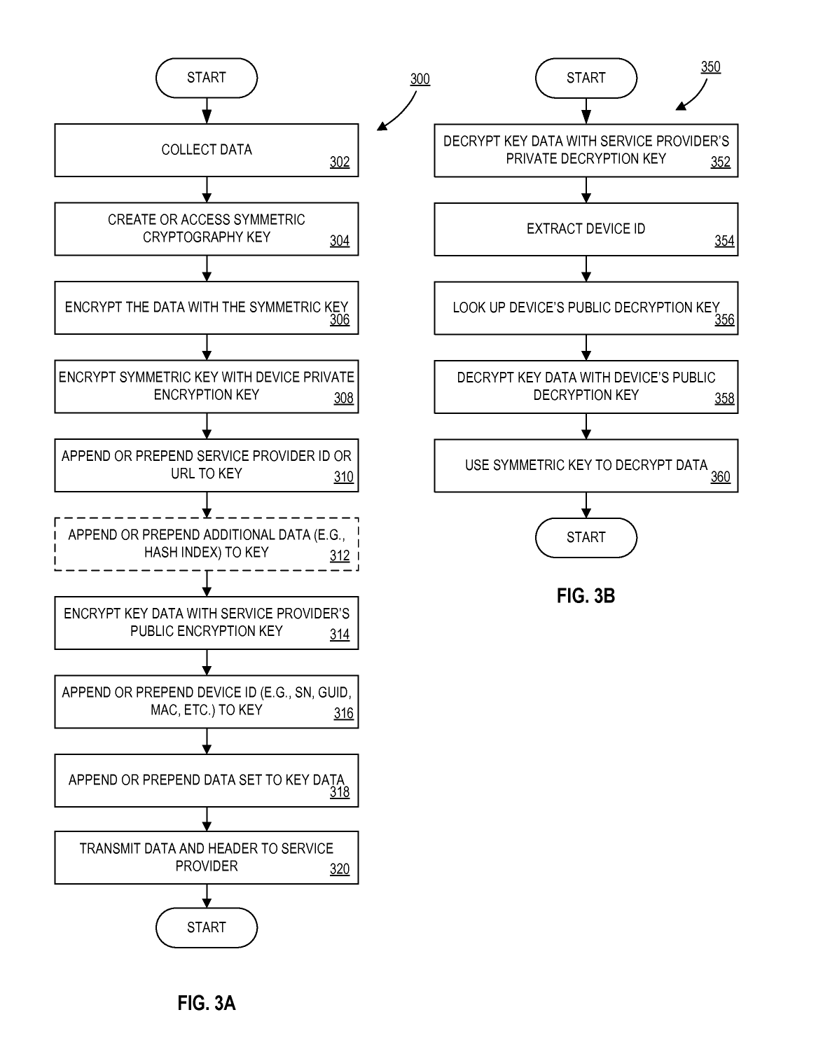

In one embodiment, data capture device 210 includes a data capture engine 212, such as an image scanner, RFID scanner, barcode reader, magnetic card reader, etc. In one embodiment, the captured data may be stored in data storage 216, such as a memory, a database, etc. In order to enable trust in the transfer for the captured data beyond the confines of data capture device 210, data security engine 214 performs one or more encryption processes on the captured data. For example, data security engine creates symmetric encryption keys, access symmetric encryption keys stored in storage 216, access and encrypt data with the data capture device's 210 private encryption key, access and encrypt data with service provider's 201 public encryption key, etc. The different encryptions, and order of encryptions, performed by data security engine 214 are discussed below in FIGS. 3A-6B.

In one embodiment, data security engine 214 optionally attaches data to the captured data before or after encryption, such as hash values, device identifiers, service provider identifiers, instructions to be used to process the captured data, etc. In one embodiment, the additional data is used by service provider 201 to track captured data, ensure data integrity, or process the captured data.

In one embodiment, data capture device 210 transmits the encrypted form of the captured data to service provider 201 via communications interface 218. As discussed above, the transmission may occur via one or more intermediate computing device or network nodes (not shown), such as tablet computers, personal computer, server computer systems, routers, etc.

In one embodiment, service provider 201 receives the encrypted form of the captured data at communications interface 252. In one embodiment, communications interface 252 stores the received data in data storage 256, or passes the received data to service security engine 254. In one embodiment, service security engine 254 performs one or more decryption processes, complementary to those performed by data security engine 214 at data capture device 210, to decrypt the transferred data. In one embodiment, service security engine 254 further extracts any additional data, such as hash values, instructions, device identifiers, etc. from the decrypted data. In one embodiment, service security engine 254 utilizes the hash values to authenticate the integrity of data, use identifiers to log data transfers, transactions, etc., or use instructions to process the received data.

In one embodiment, service security engine 254 stores the decrypted data and extracted data in data storage 256. In one embodiment, service security engine 254 further provides the decrypted data, and any instructions, to service processor 258. In one embodiment, service processor 258 processes the received data, such as processing a financial transaction, logging data, performing a query based on the received data, etc. In one embodiment, service processor 258 may further act as a proxy to another computing device to processes the received data.

In one embodiment, service provider 201 may transfer encrypted data to data capture device 210 in a manner similar to that discussed herein.

FIG. 3A is a flow diagram of one embodiment of a process 300 performed at a data capture device to enable high security and provides no access to captured data, or to the authentication function, until a service provider decrypts it. The process is performed by processing logic that may comprise hardware (circuitry, dedicated logic, etc.), software (such as is run on a general purpose computer system or a dedicated machine), or a combination of both. In one embodiment, the process 300 is performed by data capture device 110 or 210.

These embodiments employ a symmetric key, or key pair, to encrypt and decrypt the data and public/private key pairs to encrypt and decrypt the symmetric key itself and any associated data and metadata.

Referring to FIG. 3A, the process begins by processing logic capturing data (processing block 302). In one embodiment, the data is captured by an image scanner, RFID scanner, barcode reader, magnetic card reader, etc. Other forms of data may be captured and processed by processing logic according to the discussion herein.

Processing logic creates or accesses a symmetric cryptography key (processing block 304). In one embodiment, the symmetric key is a symmetric key, or key pair, stored by processing logic, which was previously generated by a data capture device, a service provider, or another device. In another embodiment, processing logic utilizes a key generator to create the symmetric cryptography key, or key pair. Processing logic then encrypts the captured data with the symmetric key (processing block 306).

In one embodiment, processing logic then encrypts the symmetric key with a private encryption key of the data capture device (processing block 308), and appends or prepends a service provider's ID or URL to the encrypted key (processing block 310). Thereafter, processing logic optionally appends or prepends additional data, such as a hash index to the encrypted key (processing block 312). In one embodiment, the hash index may be subsequently used to verify integrity of transferred data, or log the passing of the transferred data.

In one embodiment, processing logic encrypts the key data with a service provider's public encryption key (processing block 314). Next, processing logic appends or prepends the capture device's ID (e.g., a serial number, a GUID, a MAC address, etc.) to the key (processing block 316) and appends or prepends a data set to the key data (processing block 318). Finally, processing logic transmits the data and header to the service provider (processing block 320).

FIG. 3B is a flow diagram of a process 350, which is complementary to the process performed in FIG. 3A, performed at a service provider with high security and a symmetric key. The process is performed by processing logic that may comprise hardware (circuitry, dedicated logic, etc.), software (such as is run on a general purpose computer system or a dedicated machine), or a combination of both. In one embodiment, the process 350 is performed by service provider 101 or 201.

Referring to FIG. 3B, the process begins by processing logic decrypting key data with the service provider's private decryption key (processing block 352). Next, processing logic extracts the capture device's ID (e.g., the appended or prepended serial number, the GUID, the MAC address, etc.) from the data (processing block 354). In one embodiment, processing logic utilizes the extracted ID for the data capture device to look up the data capture device's public decryption key (processing block 356). Subsequently, processing logic decrypts the key data with the data capture device's public decryption key (processing block 358). Finally, processing logic uses the symmetric key obtained at processing block 358 to decrypt the data (processing block 360).

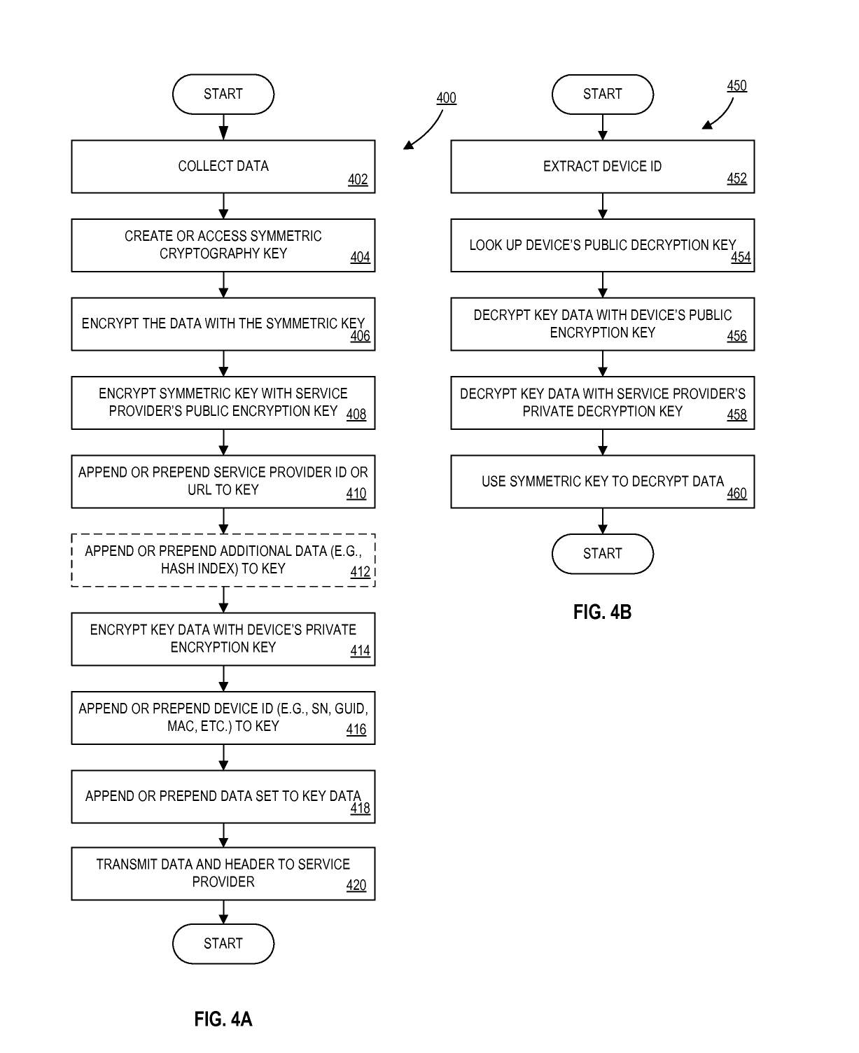

FIG. 4A is a flow diagram of one embodiment of a process 400 performed at a data capture device that enables authentication that may occur in many places, and security that may occur at the recipient. The process is performed by processing logic that may comprise hardware (circuitry, dedicated logic, etc.), software (such as is run on a general purpose computer system or a dedicated machine), or a combination of both. In one embodiment, the process 400 is performed by data capture device 110 or 210.

Referring to FIG. 4A, the process begins by processing logic collecting data (e.g., scanning documents/images, reading an RFID chip, scanning a magnetic card strip, etc.) (processing block 402). In one embodiment, processing logic creates or accesses a symmetric cryptography key (processing block 404), and encrypts the captured data with the symmetric key (processing block 406).

In one embodiment, processing logic encrypts the symmetric key with a service provider's public encryption key (processing block 408). Processing logic also appends or prepends a service provider's ID or URL to the encrypted key (processing block 410). Thereafter, processing logic optionally appends or prepends additional data (e.g., a hash index value) to the key (processing block 412).

In one embodiment, processing logic encrypts the key data, along with the additional data, with a private encryption key of the data capture device (processing block 414). Processing logic then appends or prepends a device ID (e.g., serial number, GUID, MAC) to the key (processing block 416) and appends or prepends a data set to the key data (processing block 418). Finally, processing logic transmits the data and header to the web service (processing block 420).

FIG. 4B is a flow diagram of a process 450, which is complementary to the process of FIG. 4A, performed at a service provider that includes authentication first and using a symmetric key. The process is performed by processing logic that may comprise hardware (circuitry, dedicated logic, etc.), software (such as is run on a general purpose computer system or a dedicated machine), or a combination of both. In one embodiment, the process 450 is performed by service provider 101 or 201.

Referring to FIG. 4B, the process begins by processing logic extracting the device ID for a data capture device from received data (processing block 452) and looking up the data capture device's public decryption key (processing block 454). In one embodiment, processing logic decrypts the key data with the data capture device's public decryption key (processing block 456). Processing logic then decrypts the key data with service provider's private decryption key (processing block 458). Finally, processing logic uses the decrypted symmetric key to decrypt the data (processing block 460).

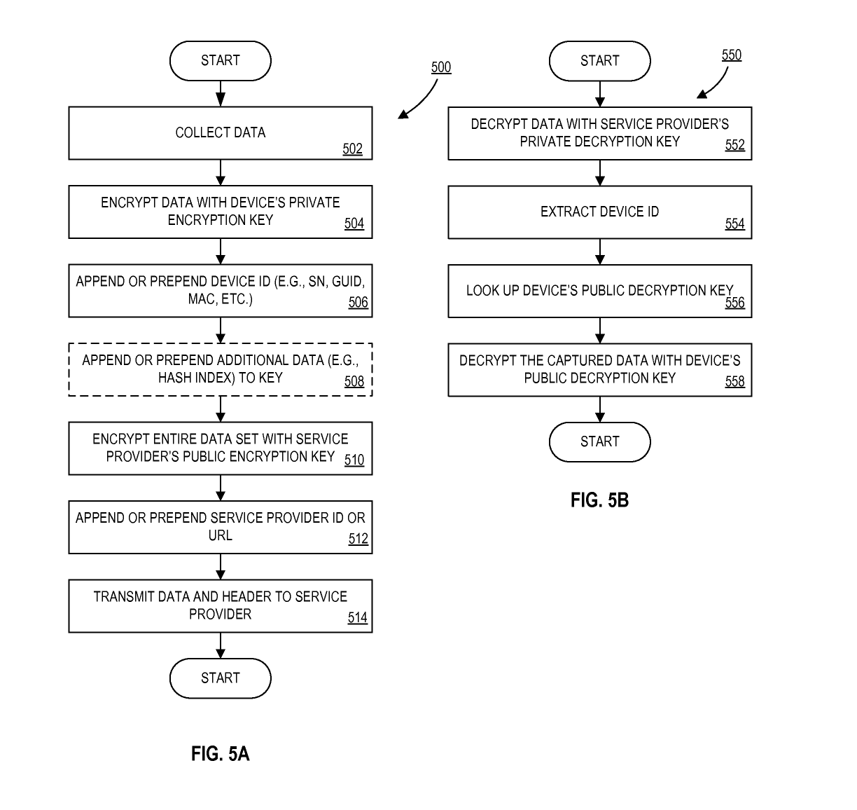

FIG. 5A is a flow diagram of one embodiment of a process 500 performed at a data capture device without symmetric encryption while maintaining a high level of security. The process is performed by processing logic that may comprise hardware (circuitry, dedicated logic, etc.), software (such as is run on a general purpose computer system or a dedicated machine), or a combination of both. In one embodiment, the process 500 is performed by data capture device 110 or 210.

Referring to FIG. 5A, the process begins by processing logic collecting data (e.g., scanning documents/images, reading an RFID chip, scanning a magnetic card strip, etc.) at the data capture device (processing block 502). In one embodiment, processing logic encrypts data with a data capture device's private encryption key (processing block 504) and appends or prepends an ID for the data capture device (e.g., serial, GUID, MAC, etc.) to the key (processing block 506). Processing logic then optionally appends or prepends additional data (e.g., a hash index) to the key (processing block 508) and encrypts the entire data set with a service provider's public encryption key (processing block 510).

In one embodiment, processing logic then appends or prepends a service provider's ID or URL to the key (processing block 512). Finally, processing logic transmits the data and header to the service provider (processing block 514).

FIG. 5B is a flow diagram of one embodiment of a process 550, which is complementary to the process of FIG. 5A, performed at a service provider with high security using asymmetric keys. The process is performed by processing logic that may comprise hardware (circuitry, dedicated logic, etc.), software (such as is run on a general purpose computer system or a dedicated machine), or a combination of both. In one embodiment, the process 550 is performed by service provider 101 or 201.

Referring to FIG. 5B, the process begins by processing logic decrypting received encrypted data with a private decryption key of the service provider (processing block 552) and extracting the data capture device's ID from the decrypted key (processing block 554). Processing logic looks up the data capture device's public decryption key with the extracted ID data (processing block 556) and decrypts the captured data with the device public encryption key (processing block 558).

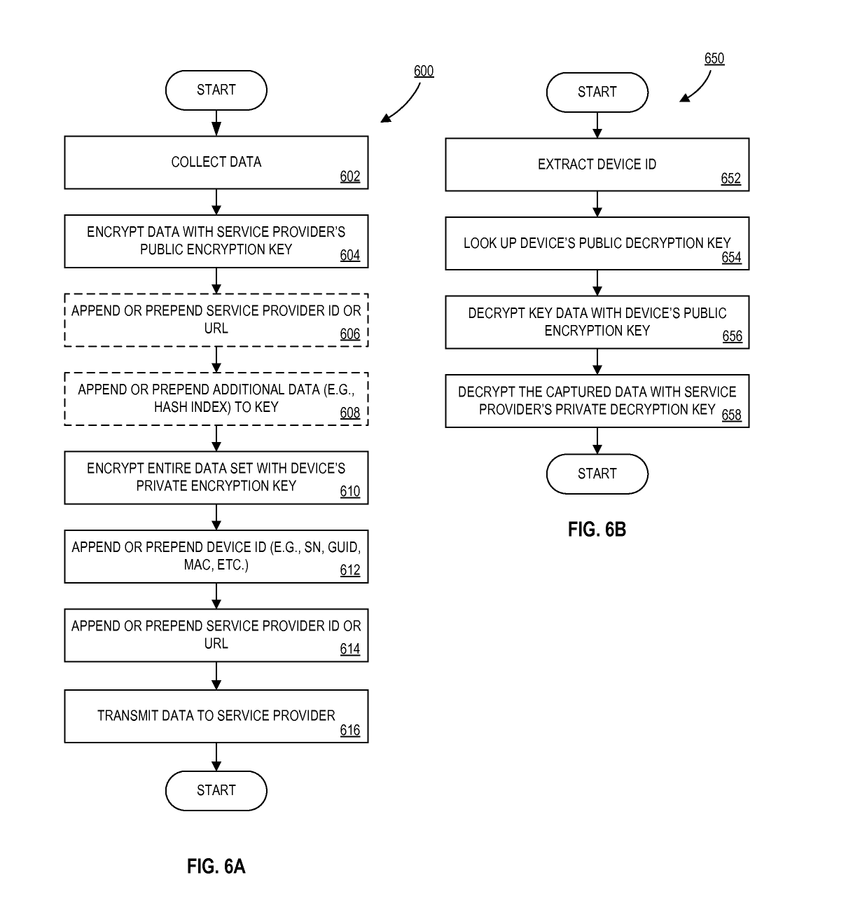

FIG. 6A is a flow diagram of a process 600 performed at a data capture device with no symmetric encryption, and where authentication may be performed at many locations with security at the recipient. The process is performed by processing logic that may comprise hardware (circuitry, dedicated logic, etc.), software (such as is run on a general purpose computer system or a dedicated machine), or a combination of both. In one embodiment, the process 600 is performed by data capture device 110 or 210.

Referring to FIG. 6, the process begins by processing logic collecting data (e.g., scanning documents/images, reading an RFID chip, scanning a magnetic card strip, etc.) at the data capture device (processing block 602). Next, the processing logic encrypts the captured data with the public encryption key of a service provider (processing block 604).

In one embodiment, processing logic optionally appends or prepends the service provider's ID or URL to the encrypted data (processing block 606). In one embodiment, processing logic further optionally appends or prepends additional data (e.g., a hash index) (processing block 608) to the encrypted data.

Processing logic then encrypts the entire data set with a private encryption key of the data capture device (processing block 610) and appends or prepends the data capture device's ID (e.g., the data capture device's serial number, GUID, MAC, etc.) to the encrypted data set (processing block 612). Processing logic appends or prepends the service provider's ID or URL to the encrypted data set (processing block 614), and transmits the data to the service provider (processing block 616).

FIG. 6B is a flow diagram of a process, which is complementary to the process of FIG. 6A, performed at a service provider where authentication occurs first using asymmetric keys. The process is performed by processing logic that may comprise hardware (circuitry, dedicated logic, etc.), software (such as is run on a general purpose computer system or a dedicated machine), or a combination of both. In one embodiment, the process 650 is performed by service provider 101 or 201.

Referring to FIG. 6B, the process begins by processing logic extracting the data capture device's ID from received encrypted data (processing block 652) and looking up the data capture device's public decryption key (processing block 654). In one embodiment, processing logic decrypts data with the data capture device's public decryption key (processing block 656). Processing logic then decrypts the captured data with the service provider's private decryption key (processing block 658).

In other embodiments, a symmetric key is used to encrypt and decrypt the data for authentication only. The symmetric key is then encrypted with the authentication public/private key pair. Security is provided by encrypting the entire data file with the security public encryption key either before or after authentication.

In other embodiments, a symmetric key is used to encrypt and decrypt the data for security only. The symmetric key is then encrypted with the security public/private key pair. Authentication is provided by encrypting the entire data file with the authentication private encryption key either before or after authentication.

### Exemplary Applications

The figures and discussion above enable several forms of trust for the transfer and processing of data. In the embodiments discussed above, the several forms of trust are enabled through the use of a series of encryptions performed on data and/or different encryption keys. The trust afforded by the techniques discussed herein enable one or more of security (i.e., only a destination device can decode encrypted data), authentication (i.e., only a specific data capture device could possibly have transmitted data to a destination device), and integrity and tracking (i.e., hash values computed from data enable verification and tracking of the data).

Below are embodiments of application and deployment scenarios that benefit from the encryption and trust enablement techniques discussed herein.

In one exemplary embodiment, the techniques discussed herein are beneficial to financial transactions, which demand a high level of security. In this exemplary embodiment, a magnetic card reader/writer and image scanner act as the data capture device, and the service provider acts as the only and final security destination and authenticator. Although the examples below discusses a financial application, the same embodiment can be used for health care transactions of both financial and medical data.

In the embodiments discussed herein, a data capture device, such as the data capture device 110 discussed above, may scan check images, which are transferred and processed by a bank service provider server. As another embodiment, a data capture device may scan fingerprint images, which are transmitted, logged, and stored at a repository of such images. As yet another embodiment, a data capture device may scan the magnetic strip on a credit, debit, or cash card, and transmit the card information to a merchant and/or bank for processing. The embodiments discussed herein are suitable for the capture, and transfer, of numerous forms of digital data.

In one embodiment, remote deposit capture may be carried out with a data capture device, such as an image scanner and/or a magnetic card reader. The data capture device may be coupled with a computer, tablet, or smart phone for interacting with a website to perform the remote deposit capture. When the encryption techniques, as discussed above, are deployed in the image scanner and/or magnetic card reader, a user, transaction, data capture, etc. may be securely and reliably transferred and authenticated. Furthermore, the authentication enables trust for subsequent financial transactions (e.g., withdrawal or deposit of funds on a cash card, depositing a check, charging a credit card, scanning a barcode, reading an RFID chip, etc.).

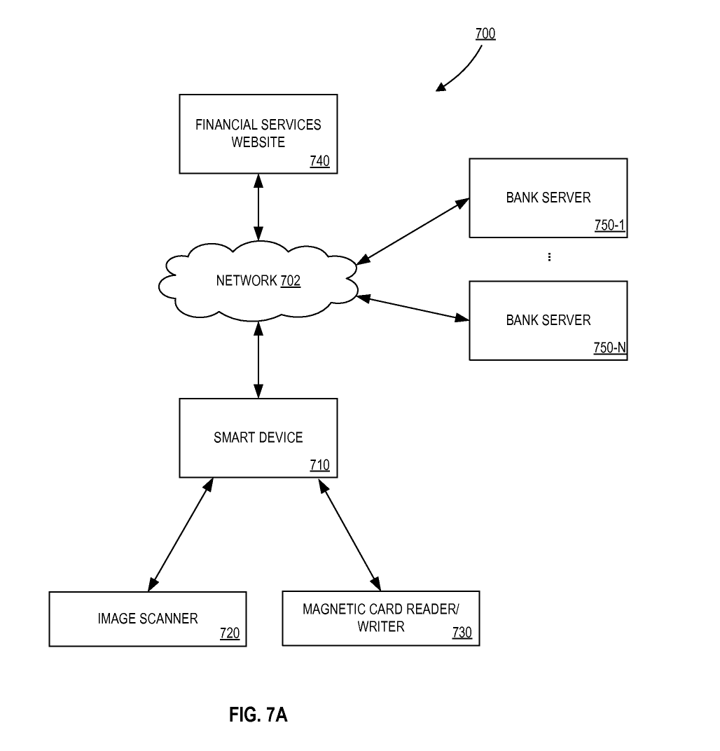

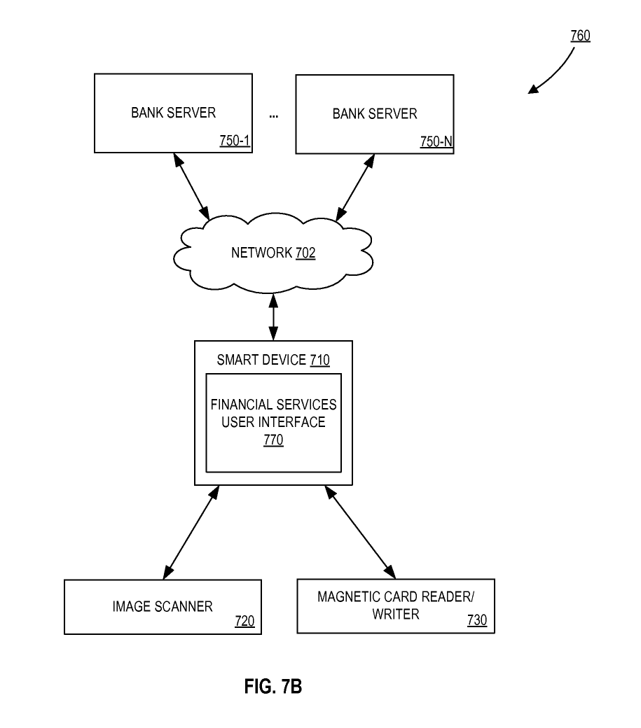

FIG. 7A illustrates one embodiment of a system 700 in which the trust enablement techniques discussed herein may be deployed. In one embodiment, the system includes a smart device 710, such as a computer, tablet device, television, MP3 player, automobile, or smart phone securely connected to the Internet, financial, or other network. Securely connected to the smart device 710 is a read/write device 730 capable of reading and writing on a physical media. The connection between the smart device 710 and the read/write device 730 can be wired (e.g., USB) or wireless (e.g., WiFi, Bluetooth). In one embodiment, the image scanner is the camera function of the smart device. In one embodiment, the card read/write function is activated in response to a Near Field Communication (NFC) function of the smart device 710.

In one embodiment, the read/write device 730 performs authentication and altering funds amounts on credit cards, bank accounts, etc. In some embodiments, the authentication and altering of funds may occur in a single transaction, or multiple transactions. In one embodiment, the altering of funds may include either adding funds or subtracting funds. For example, a cash card, such as a pre-paid card branded with Visa™, MasterCard™, etc., may have money added to it by an end-user with the system of FIG. 7A, thereby adding funds to the card while subtracting the equivalent amount from the user's bank account. As another example, a user may scan the image of a check on image scanner 720, and then after authentication deposit the check in the user's bank account.

In one embodiment, smart device 710 access website 740 via network 702. In one embodiment, the website 740 is a service provider that provides various financial services (e.g., banking, merchant, shopping, retail, etc.). Service provider website 740, however, could provide other services, such as data storage, search, security, etc. In one embodiment, the website 740 may prompt a user to swipe a card at magnetic card read/write device 730. Furthermore, card read/write device 730 may visually indicate, such as by activating a green light, when card read/write device 730 is ready to scan a card. The magnetic card read/write device 730 reads the ID and/or values from the card, in response to the card being swiped by a user, and communicates the ID and/or values to the website 740 via the smart device 710.

In one embodiment, the website 740 may request authentication, such as entry of a PIN number, login information, biometric identification scans, etc. entered by a user at image scanner 720 or another peripheral device (not shown).

In one embodiment, the card ID and/or values, as well as the authentication data, may be transferred to website 740 by the magnetic card reader 730 using one of the processes discussed above in FIG. 3A, 4A, 5A, or 6A to securely transmit the data in encrypted form. Furthermore, the website 740 may then utilize one of the corresponding processes discussed above in FIG. 3B, 4B, 5B, or 6B to decrypt the received information. After website 740 decrypts the authentication data, website 740 transmits data for display on smart device 710. In one embodiment, the data may include a credit card's balance, a cash card's status/value, or other relevant information. Furthermore, the website 740 enables a user to make selections, add or subtract value from a card, store, account, transportation ticket, etc., authorize purchases on a credit card, etc. In response to one or more user selections, website 740 performs the appropriate accounting with a user's financial institution via communication with one of bank servers 750-1 through 750-N. Communication of data between the website 740 and a bank server 750-i may also utilize the secure transfer techniques discussed above in FIGS. 3A-6B. Thus, in one embodiment, all communications may be secured, and satisfy Check Clearing for the 21st Century Act (Check 21) compliance requirements. In one embodiment, in order to alter a transaction, the card may be required by website 740 or a bank server 750-i to be swiped a second time. Furthermore, in one embodiment, the altering, or writing to a card, is achieved by authorizing alterations in the online accounting associated with the card and IDs associated with the card. In other words, after authentication, the online balance can be presented and, using the website 740, credits or debits can be made, displayed, and processed by corresponding bank servers 750-1 through 750-N.

In one embodiment, the URL and/or login information for a user, website 740, bank server 750-i, etc. is contained on a card that the read/write device 730 reads. In some embodiments, the scanning of the card at read/write device 730 initiates the interaction with website 740. Furthermore, although value is commonly considered monetary, the value being added or subtracted to a card, account, ticket, etc. may be some type of point or other non-monetary system, such as a customer loyalty clubs (e.g., American Airlines Frequent Flyer Miles™).

As discussed above, in alternate embodiments, the magnetic card reader can be replaced by other types of identification readers, e.g. RFID, barcode, biometric, document scanner, etc., or the smart device can be replaced with a reader that is directly connected (wired or wireless) to the network application. Furthermore, as illustrated in FIG. 7B the website 740 may be replaced with a user interface 770 executed on the smart device 710, such as a user interface, app, etc. executed on a smartphone, tablet, etc.

Enabling a magnetic card, such as a credit card, cash card, or ATM card to be scanned, and then transactions processed, provides a user experience that is as essentially the same as a commercial automated teller machine interaction. However, utilizing the encryption and data transfer techniques discussed above, enables secure data handling, visual feedback, and a simple interface that may mimic an ATM. Furthermore, by leveraging existing computer device hardware (e.g., a smartphone coupled with a magnetic card reader, a scanner coupled with a personal computer, etc.), there is minimal hardware or software setup and equipment expense.

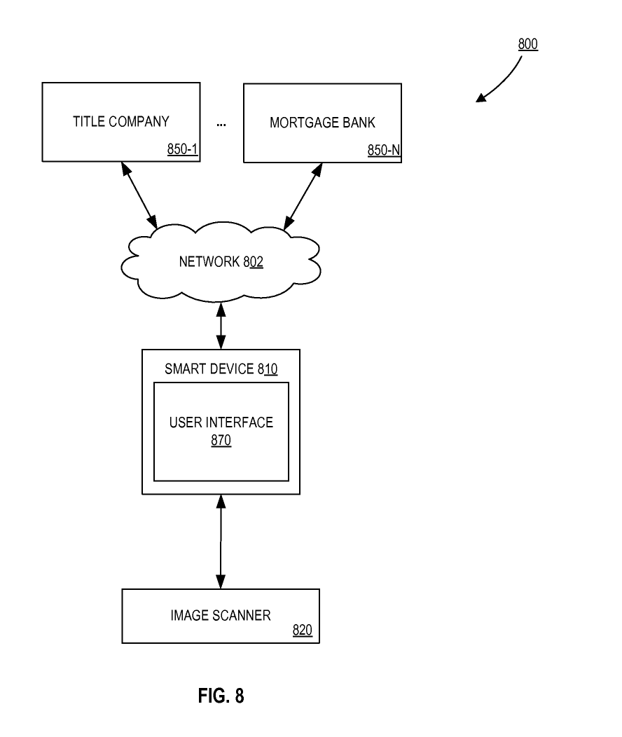

FIG. 8 illustrates another embodiment of a system 800 in which the trust enablement techniques discussed herein may be deployed. The embodiment illustrated in FIG. 8 is an example of a business system suitable for use by a Real Estate Agent. The Agent has many different types of documents to send to many different shareholders, i.e. a mortgage broker, bank, title company, city hall, etc.

In one embodiment, the data capture device 820 is an image scanner coupled with smart device 810. In one embodiment, user interface 870 allows the Agent to select how the document will be handled (i.e. the instruction set). The data is captured, processed and sent via the Network 802 using the secure transfer techniques discussed above in FIGS. 3A-6B. In one embodiment, the network 802 has a web service that decrypts, comprehends the instruction set, and sends the data to the proper service (e.g., Title Company 850-1 or Mortgage Broker 850-N). In some embodiments, the retransmission of the data from the network 802 to one or more of the services (850-1 through 850-N) uses the secure transfer techniques discussed above in FIGS. 3A-6B.

### Exemplary Computers, Networks, and Smart Devices

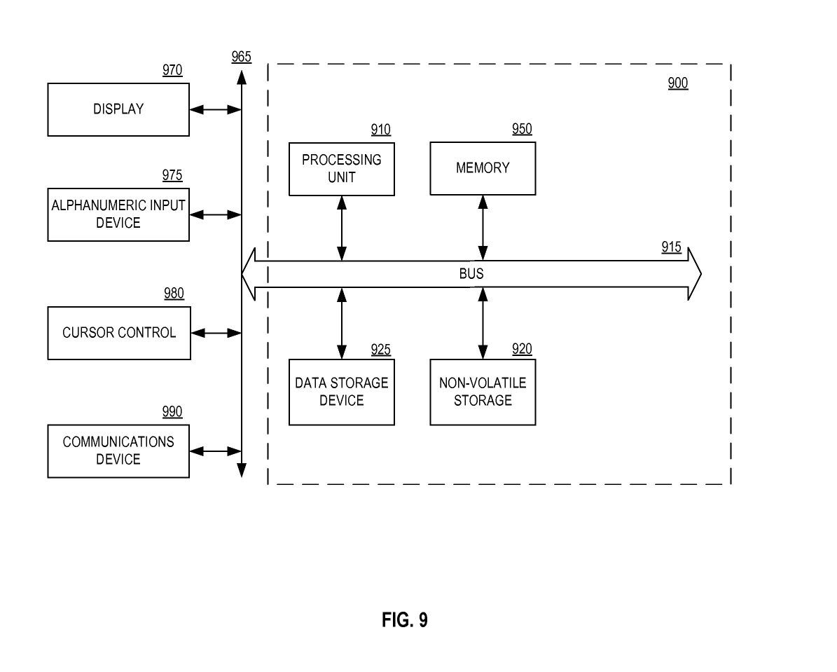

FIG. 9 is one embodiment of a computer system that may be used with the present invention. It will be apparent to those of ordinary skill in the art, however that other alternative systems of various system architectures may also be used.

The data processing system illustrated in FIG. 9 includes a bus or other internal communication means 915 for communicating information, and a processor 910 coupled to the bus 915 for processing information. The system further comprises a random access memory (RAM) or other volatile storage device 950 (referred to as memory), coupled to bus 915 for storing information and instructions to be executed by processor 910. Main memory 950 also may be used for storing temporary variables or other intermediate information during execution of instructions by processor 910. The system also comprises a read only memory (ROM) and/or static storage device 920 coupled to bus 915 for storing static information and instructions for processor 910, and a data storage device 925 such as a magnetic disk or optical disk and its corresponding disk drive. Data storage device 925 is coupled to bus 915 for storing information and instructions.

The system may further be coupled to a display device 970, such as a cathode ray tube (CRT) or a liquid crystal display (LCD) coupled to bus 915 through bus 965 for displaying information to a computer user. An alphanumeric input device 975, including alphanumeric and other keys, may also be coupled to bus 915 through bus 965 for communicating information and command selections to processor 910. An additional user input device is cursor control device 980, such as a mouse, a trackball, stylus, or cursor direction keys coupled to bus 915 through bus 965 for communicating direction information and command selections to processor 910, and for controlling cursor movement on display device 970.

Another device, which may optionally be coupled to computer system 900, is a communication device 990 for accessing other nodes of a distributed system via a network. The communication device 990 may include any of a number of commercially available networking peripheral devices such as those used for coupling to an Ethernet, token ring, Internet, or wide area network. The communication device 990 may further be a null-modem connection, or any other mechanism that provides connectivity between the computer system 900 and the outside world. Note that any or all of the components of this system illustrated in FIG. 9 and associated hardware may be used in various embodiments of the present invention.

It will be appreciated by those of ordinary skill in the art that any configuration of the system may be used for various purposes according to the particular implementation. The control logic or software implementing the present invention can be stored in main memory 950, mass storage device 925, or other storage medium locally or remotely accessible to processor 910.

It will be apparent to those of ordinary skill in the art that the system, method, and process described herein can be implemented as software stored in main memory 950 or read only memory 920 and executed by processor 910. This control logic or software may also be resident on an article of manufacture comprising a computer readable medium having computer readable program code embodied therein and being readable by the mass storage device 925 and for causing the processor 910 to operate in accordance with the methods and teachings herein.

The present invention may also be embodied in a handheld or portable device containing a subset of the computer hardware components described above. For example, the handheld device may be configured to contain only the bus 915, the processor 910, and memory 950 and/or 925. The handheld device may also be configured to include a set of buttons or input signaling components with which a user may select from a set of available options. The handheld device may also be configured to include an output apparatus such as a liquid crystal display (LCD) or display element matrix for displaying information to a user of the handheld device. Conventional methods may be used to implement such a handheld device. The implementation of the present invention for such a device would be apparent to one of ordinary skill in the art given the disclosure of the present invention as provided herein.

The present invention may also be embodied in a special purpose appliance including a subset of the computer hardware components described above. For example, the appliance may include a processor 910, a data storage device 925, a bus 915, and memory 950, and only rudimentary communications mechanisms, such as a small touch-screen that permits the user to communicate in a basic manner with the device. In general, the more special-purpose the device is, the fewer of the elements need be present for the device to function.

It is to be understood that the above description is intended to be illustrative, and not restrictive. Many other embodiments will be apparent to those of skill in the art upon reading and understanding the above description. The scope of the invention should, therefore, be determined with reference to the appended claims, along with the full scope of equivalents to which such claims are entitled.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as may be suited to the particular use contemplated.

We claim:

1. A method, comprising:
capturing data with a data capture device;
encrypting the data with a first encryption key;
encrypting the first encryption key with a second encryption key to generate a first encrypted key data;
encrypting the first encrypted key data with a third encryption key to generate a second encrypted key data; and
transmitting the encrypted data and the second encrypted key data to a remote service provider over a network.

2. The method of claim 1, wherein the first encryption key is a symmetric encryption key, the second encryption key is a private encryption key of the data capture device, and the third encryption key is a public encryption key of the remote service provider.

3. The method of claim 1, wherein the first encryption key is a symmetric encryption key, the second encryption key is a public encryption key of the remote service provider, and the third encryption key is a private encryption key of the data capture device.

4. The method of claim 1, further comprising:
adding an identifier corresponding to the remote service provider to the first encrypted key data.

5. The method of claim 4, further comprising:
adding a hash value computed from the data to the first encrypted key data.

6. The method of claim 4, further comprising:
adding a device identifier corresponding to the data capture device to the second encrypted key data.

7. The method of claim 1, wherein the data capture device is one of an image scanner, barcode scanner, radio frequency identifier scanner, or a magnetic card reader.

8. The method of claim 1, wherein the data capture device is a magnetic card reader to capture financial account data from a magnetic strip on a card, and the remote service provider is a financial service provider to processes a financial services transaction based at least on in part on the financial account data.

9. The method of claim 8, wherein the financial services transaction withdraws a monetary value from a financial account associated with the financial account data captured from the card.

10. The method of claim 8, wherein the financial services transaction deposits a monetary value associated with the financial account data on the card.

11. The method of claim 8, wherein the financial services transaction deposits a monetary value associated with the financial account data into an financial account associated with the card.

12. The method of claim 8, wherein the financial account data is encrypted with the first encryption key to form the encrypted data, and the encrypted data is transmitted to the remote service provider via an intermediate computing device to which the data capture device is coupled.

13. The method of claim 1, wherein the data capture device is an image scanner to capture image data of a real estate transaction document, and the remote service provider is a financial service provider to processes a real estate transaction based at least on in part on information in the real estate transaction document.

14. A non-transitory computer readable storage medium including instructions that, when executed by a processor, cause the processor to perform a method comprising:
capturing data with a data capture device;
encrypting the data with a first encryption key;
encrypting the first encryption key with a second encryption key to generate a first encrypted key data;
encrypting the first encrypted key data with a third encryption key to generate a second encrypted key data; and
transmitting the encrypted data and the second encrypted key data to a remote service provider over a network.

15. An apparatus, comprising:
a data capture device to capture data;
an encryption engine coupled with the data capture device to encrypt the data with a first encryption key,
encrypt the first encryption key with a second encryption key to generate a first encrypted key data, and
encrypt the first encrypted key data with a third encryption key to generate a second encrypted key data; and
a communications interface coupled with the encryption engine to transmit the encrypted data and the second encrypted key data to a remote service provider over a network.

16. A method, comprising:
capturing data with a data capture device;
encrypting the data with first encryption key;
encrypting the encrypted data with a second encryption key; and
transmitting the data encrypted with the second encryption key to a remote service provider over a network.

17. The method of claim 16, wherein the first encryption key is a private encryption key of the data capture device, and the second encryption key is a public encryption key of the remote service provider.

18. The method of claim 17, further comprising:
adding a device identifier to the data encrypted with the private encryption key of the data capture device prior to the encryption with the public encryption key of the remote service provider.

19. The method of claim 16, wherein the first encryption key is a public encryption key of the remote service provider, and the second encryption key is a private encryption key of the data capture device.

20. The method of claim 19, further comprising:
adding a device identifier to the data encrypted with the private encryption key of the data capture device after the encryption with the private encryption key of the data capture device.

21. The method of claim 16, wherein the data capture device is a magnetic card reader to capture financial account data from a magnetic strip on a card, and the remote service provider is a financial service provider to processes a financial services transaction based at least on in part on the financial account data.

22. The method of claim 21, wherein the financial services transaction withdraws a monetary value from a financial account associated with the financial account data captured from the card.

23. The method of claim 21, wherein the financial services transaction deposits a monetary value associated with the financial account data on the card.

24. The method of claim 21, wherein the financial services transaction deposits a monetary value associated with the financial account data into an financial account associated with the card.

25. The method of claim 16, wherein the data capture device is an image scanner to capture image data of a real estate transaction document, and the remote service provider is a financial service provider to processes a real estate transaction based at least on in part on information in the real estate transaction document.

26. A non-transitory computer readable storage medium including instructions that, when executed by a processor, cause the processor to perform a method comprising:
capturing data with a data capture device;
encrypting the data with first encryption key;
encrypting the encrypted data with a second encryption key; and
transmitting the data encrypted with the second encryption key to a remote service provider over a network.

27. An apparatus, comprising:
a data capture device to capture data;
an encryption engine coupled with the data capture device to encrypt the data with first encryption key;
encrypt the encrypted data with a second encryption key; and
a communications interface coupled with the encryption engine to transmit the data encrypted with the second encryption key to a remote service provider over a network.

28. A method, comprising:
receiving data encrypted by a data capture device at a remote service provider, wherein the received encrypted data includes encrypted key data and an encrypted form of data captured by the data capture device;
decrypting the encrypted key data with a first decryption key to obtain a second encrypted key data;
decrypting the second encrypted key data with a second decryption key to obtain a symmetric decryption key;
decrypting the encrypted form of data captured by the data capture device with the symmetric decryption key; and
processing the data captured by the data capture device.

29. The method of claim 28, wherein the first decryption key is a private decryption key of the remote service provider, and the second decryption key is a public decryption key associated with the data capture device.

30. The method of claim 28, wherein the first decryption key is a public decryption key associated with the data capture device, and the second decryption key is a private decryption key of the remote service provider.

31. A method, comprising:
receiving data encrypted by a data capture device at a remote service provider, wherein the received encrypted data includes an encrypted form of data captured by the data capture device;
decrypting the encrypted form of data captured by the data capture device with a first decryption key to obtain a second encrypted form of data captured by the data capture device;
decrypting the second encrypted form of data captured by the data capture device with a second decryption key to obtain the data captured by the data capture device; and
processing the data captured by the data capture device.

32. The method of claim 31, wherein the first decryption key is a private decryption key of the remote service provider, and the second decryption key is a public decryption key associated with the data capture device.

33. The method of claim 31, wherein the first decryption key is a public decryption key associated with the data capture device, and the second decryption key is a private decryption key of the remote service provider.
